(19) United States
(12) Patent Application Publication
(10) Pub. No.: US 2026/0359064 A1
(43) Pub. Date: Nov. 12, 2026

(54) OFFLOADING OF CPU-DRIVEN SILICON INITIALIZATION TASKS

(71) Applicant: Intel Products IP LLC, Santa Clara, CA (US)

(72) Inventors: Rupesh THYAGARAJAN, Folsom, CA (US); Gregory LEMOS, Modesto, CA (US); Ashwyn VAN PELT, Portland, OR (US)

(21) Appl. No.: 19/717,685

(22) Filed: Jun. 24, 2026

Related U.S. Application Data
(60) Provisional application No. 63/972,216, filed on Jan. 30, 2026.

(51) Int. Cl. G06F 9/4401; G06F 9/54; G06F 21/44

(52) U.S. Cl. CPC G06F 9/4401; G06F 9/54; G06F 21/44

(57) ABSTRACT

A computing system includes a host processor configured to execute system firmware during a system startup process; one or more hardware functional blocks requiring initialization during the startup process; and an embedded controller coupled to the host processor; wherein the host processor is configured, during execution of the system firmware, to: perform one or more firmware-based hardware initialization routines; identify one or more hardware initialization operations for offloading from the host processor to the embedded controller; generate, at runtime, at least one hardware initialization payload comprising a sequence of register programming operations corresponding to the identified hardware initialization operations; and transfer the at least one hardware initialization payload to memory accessible by the embedded controller.

### CROSS-REFERENCE TO RELATED APPLICATIONS

This application claims priority to U.S. Provisional Application No. 63/972,216 filed on Jan. 30, 2026, the entire contents of which are incorporated herein by reference.

### BACKGROUND

On various platforms, the silicon initialization code executed by the host central processing unit (CPU) may account for as much as 25% of the pre-OS boot time, which in some instances may average around 300 milliseconds. Of this, only about a third, often less than 100 milliseconds, may be due to CPU-related configuration, while the remainder is typically consumed by memory, display, and I/O controller configuration. This creates a bottleneck, particularly given the serial initialization of peripherals and input/output (I/O) devices, such as, for example, Peripheral Component Interconnect Express (PCIe) and general-purpose input/output (GPIO) devices. This delay contrasts with the seamless user experience typically found in consumer electronics or i-Devices, which do not typically suffer from such boot-time delays.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a conventional boot-flow;

FIG. 2 depicts a boot-flow according to an aspect of the disclosure;

FIG. 3 depicts an offloading payload;

FIG. 4 depicts a conventional mFIT image creation;

FIG. 5 depicts a proposed mFIT Image Generation; and

FIG. 6 depicts a generalized solution.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [. . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [. . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Basic Input/Output System (BIOS) refers to system firmware stored in non-volatile memory and executed by a host processor during system startup to perform early hardware initialization, configure platform components, and initiate loading of an operating system. The BIOS may include boot-time routines for configuring processing resources, memory, input/output controllers, and/or peripheral devices.

A hardware initialization accelerator (HIA) may refer to a controller or processing engine within a system-on-chip that is configured to execute predefined hardware configuration payloads including sequences of register programming operations for initializing one or more silicon components. The HIA may operate independently of a host processor and may apply the register programming operations directly to designated hardware functional blocks based on authorized access endpoints. Such payloads may be represented as structured tables or scripts stored in non-volatile memory and loaded into memory of the accelerator for execution during system startup.

Inter-Processor Communication (IPC) refers to a signaling or messaging mechanism by which a host processor or firmware component communicates with an embedded controller or auxiliary processing engine within a system-on-chip to initiate execution of specified operations. In the context of system initialization, IPC may be used to trigger execution of one or more hardware configuration payloads by the embedded controller at designated stages of a boot process.

A hardware functional block may refer to a distinct circuit module or integrated logic unit within a system-on-chip or computing platform that is configured to perform a specific hardware function and that requires configuration or initialization during a system startup process. Hardware functional blocks may include, by way of example and without limitation, peripheral interface controllers, input/output controllers, memory controllers, display controllers, power management circuits, communication interfaces, and other specialized processing or control units. Each hardware functional block typically includes one or more programmable registers or configuration structures that are set by firmware or embedded controllers to establish operational parameters prior to normal system operation.

This principles disclosed herein utilize idle embedded controllers (engines) outside of the compute cluster within the system on chip (SoC), such as, for example, the platform management controller (PMC), to parallelize I/O silicon initialization alongside other host CPU processes. This approach may enhance any of responsiveness, efficiency, or security. Although the PMC is merely one of a number of possible embedded controllers that can be utilized for the principles disclosed herein, choosing the PMC allows this proposed solution to leverage and expand upon the PMC's existing hardware initiation accelerator function, which generally provides SoC configuration for boot critical individual hardware functional units (also referred to herein as silicon blocks or intellectual property blocks (IPs)) that require initialization prior to BIOS loading or in general for IPs not accessible by BIOS.

To optimize boot firmware execution time while maintaining configurability, a primary processor (also referred to as a first processor, or a processor implementing BIOS) may offload non-CPU and non-SystemAgent I/O silicon initialization as initialization payloads to idle engines, e.g., to idle IPs. These payloads may, for example, be created offline by using tools like modular Firmware Image Tool, or they may be created during runtime, such as based on end-user input and/or connected devices. This approach may also enhance security by requiring chipset payload contents to pass additional security engine authentication to be stored in serial peripheral interface (SPI) flash and thus may reduce the SPI flash footprint by eliminating unnecessary BIOS firmware support package (FSP) code (also referred to herein as Silicon Initialization Modules). Although this disclosure specifically refers to the PMC as executing these offloaded payloads/tasks, the PMC is used herein only for demonstrative purposes, and any available embedded controller or combination of embedded controllers may be used. That is, this solution may be expanded, such as by utilizing an initialization function with any other micro-controller within the SoC to enable offloading memory and display initialization.

The principles and methods herein result in boot time savings. They may also reduce materials costs and manufacturing costs by requiring smaller SPI flash and by speeding up the factory bring-up.

Silicon initialization routines done in BIOS (such as on the host CPU) come at a cost to boot time, as time must be spent polling, and due to the algorithmic complexity, increased SPI Flash footprint, and other taxes paid for running in the BIOS environment. The register-programming sequences in these routines may be dependent on the user-input and/or the connected peripheral devices. This register-programming sequence typically does not change after the end of manufacturing flow. Additionally, for certain customers and embedded applications, the connected peripheral devices and user-input is fixed for a given SoC implementation (e.g., for a specific stock keeping unit). These register programming sequences may be saved as a payload consumable by an offloading controller.

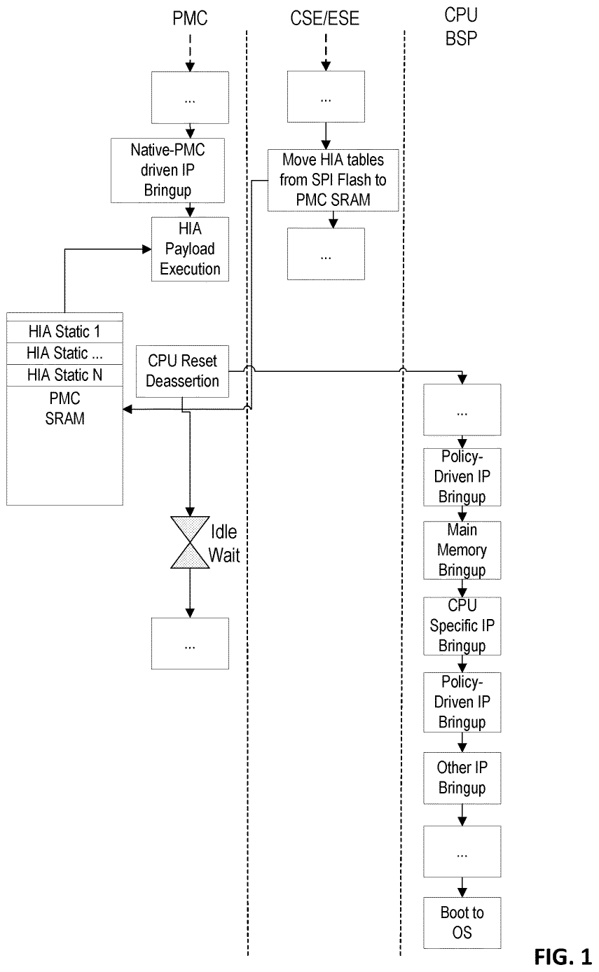

FIG. 1 depicts a conventional boot flow, which shows a largely sequential initialization process in which different system components are brought up in stages, with the host processor playing the central role. Following CPU Reset Deassertion, the system begins with native PMC-driven IP bring-up, after which CPU 106 performs CPU-specific IP initialization. Once the CPU core environment is ready, the platform proceeds into broader policy-driven IP bring-up and other IP bring-up, where various peripheral and controller blocks across the SoC are configured based on firmware policies and detected hardware.

FIG. 1 also shows the involvement of CSE/ESE 104, which transfers HIA tables from SPI flash into PMC SRAM. These tables represent static hardware initialization payloads (also referred to herein as HIA payloads) that are then executed by PMC 102 as part of the boot process. The PMC executes multiple HIA static payloads in sequence from its internal SRAM, after which it transitions into an idle or wait state. This payload execution occurs alongside or between other initialization phases and may be coordinated in a largely serialized boot flow.

After payload execution and completion of remaining IP initialization stages, the system proceeds to main memory bring-up, followed again by additional policy-driven and other IP bring-up steps. Once all required hardware components are configured, control typically transitions to boot to OS, where the operating system loader is launched. Overall, the image depicts a boot architecture where initialization tasks are primarily serialized across CPU 106 and PMC 102, with CSE/ESE 104 serving a supporting security and loading role, contributing to longer pre-OS boot times.

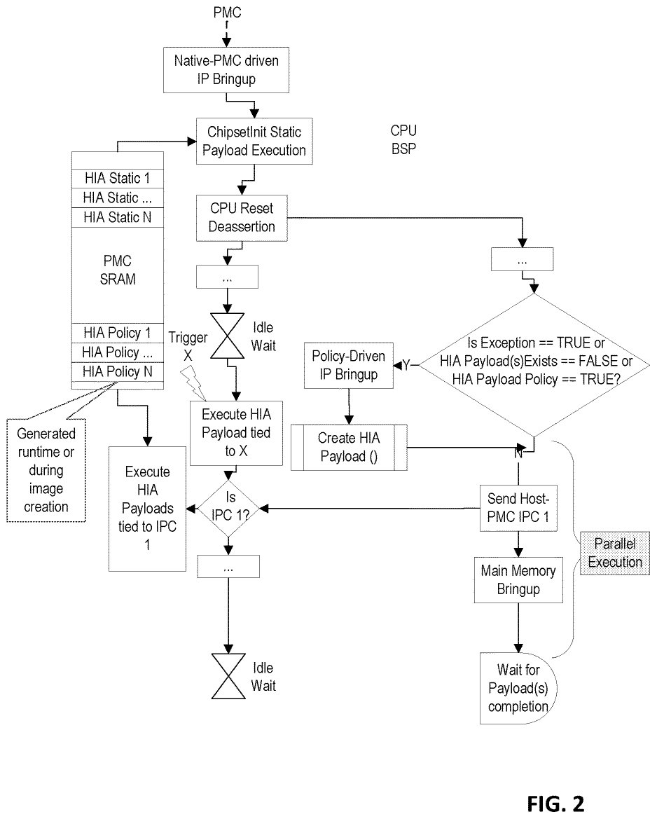

FIG. 2 depicts a proposed boot flow according to an aspect of the disclosure. Shaded portions of this figure represent key differences from the procedures in FIG. 1. The proposed boot flow shown in the figure restructures system initialization to actively leverage PMC 102 as a parallel hardware initialization engine rather than leaving it largely idle during CPU-driven firmware execution. After CPU Reset Deassertion, PMC 102 first performs its native PMC-driven IP bring-up and then immediately executes a set of static hardware initialization accelerator (HIA) payloads stored in PMC SRAM. These static payloads (labeled HIA Static 1 through HIA Static N) represent pre-generated configuration sequences created either during firmware image creation or runtime. Unlike the conventional flow, where such initialization logic is primarily executed by the host firmware on CPU 106, this proposed architecture front-loads a significant portion of silicon configuration onto PMC 102 before and during CPU bring-up.

As CPU 106 (acting as the bootstrap processor) begins its policy-driven IP bring-up, it evaluates whether exceptions exist, such as missing payloads, policy changes, or firmware updates. If exceptions are present, the CPU may dynamically create new HIA payloads. If no exceptions are present, CPU 106 may send targeted IPC triggers (for example IPC 1) to PMC 102, instructing it to execute specific payloads tied to those triggers. These IPC-triggered payloads (labeled HIA Policy 1 through HIA Policy N) are executed by PMC 102 while CPU 106 continues with other initialization tasks such as main memory bring-up. FIG. 2 explicitly highlights this parallel execution, with PMC payload execution overlapping in time with CPU-driven flows rather than occurring serially.

A key difference from the conventional boot flow in FIG. 1 is the shift from a mostly sequential initialization model to a coordinated, parallel model. That is, in FIG. 1, CSE/ESE 104 primarily served to load static HIA tables into PMC memory, after which the PMC executed them in a relatively linear sequence while the CPU handled the bulk of initialization. In the proposed flow, PMC 102 becomes an active participant throughout the boot process, executing both static and dynamically triggered payloads in response to IPC signaling from CPU 106. This reduces idle time for PMC 102, minimizes CPU firmware workload, and allows multiple silicon components to be initialized concurrently. The result is a more efficient boot process that shortens overall pre-OS startup time while maintaining policy control and secure payload handling.

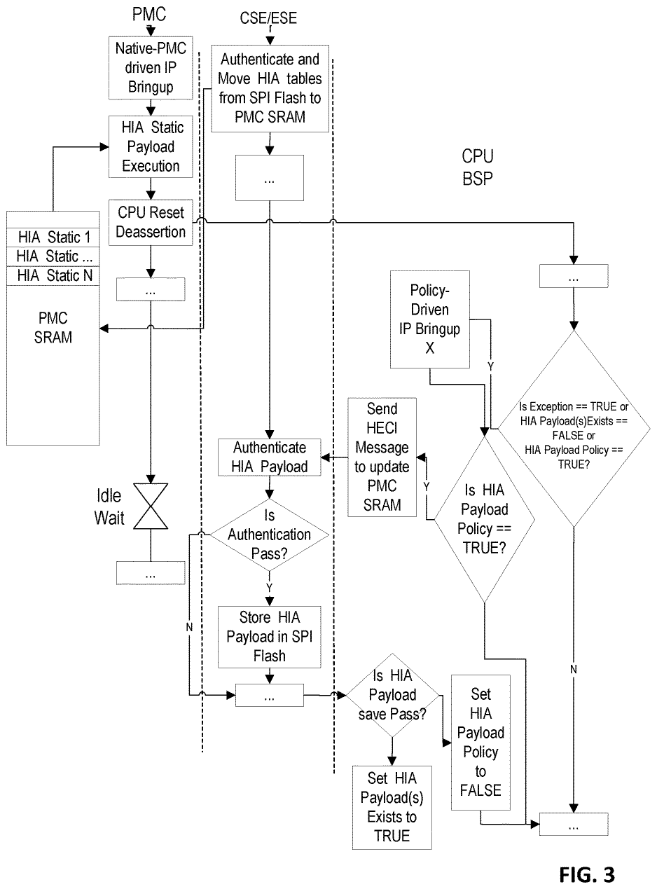

FIG. 3 depicts a coordinated runtime process for creating, authenticating, and storing a hardware initialization payload (HIA payload) that is later executed by PMC 102 to perform silicon initialization. The flow begins with PMC 102 performing native PMC-driven IP bring-up and executing any existing static HIA payloads that have already been loaded into PMC SRAM. In parallel, CSE/ESE 104 authenticates previously stored HIA tables and transfers them from SPI flash memory into PMC SRAM for execution. Following CPU Reset Deassertion, CPU 106 proceeds with policy-driven IP bring-up and evaluates a set of conditions, including whether an exception is present, whether HIA payloads already exist, or whether a payload generation policy is enabled.

If the evaluation indicates that new payloads should be generated, for example due to missing payloads, updated firmware policies, or exception scenarios, CPU 106 may initiate a process to create updated HIA payloads. When the HIA payload policy is enabled, the CPU sends a communication message (illustratively described as an HECI message) to update the contents of PMC SRAM with newly generated register programming sequences corresponding to the hardware configuration determined during policy-driven IP bring-up. These newly generated payloads represent the hardware initialization logic that would traditionally be executed directly by CPU firmware, but are instead packaged into structured payload form for execution by PMC 102.

Once the new HIA payload is generated, CSE/ESE 104 performs authentication of the payload to verify integrity and authorization. If authentication is successful, the payload is stored in SPI flash memory for persistent reuse on subsequent boots. The flow then verifies whether the save operation to SPI flash succeeded. Upon a successful save, system control logic sets a flag indicating that HIA payloads exist and disables the payload generation policy so that future boots will reuse the stored payload rather than regenerating it. If authentication or storage fails, the payload generation policy is set to false to ensure that the system falls back to conventional CPU-based initialization flows. Through this process, the figure depicts a secure, policy-controlled mechanism by which hardware initialization routines are dynamically converted into reusable payloads executed by PMC 102, enabling faster and parallelized silicon bring-up in subsequent boot cycles.

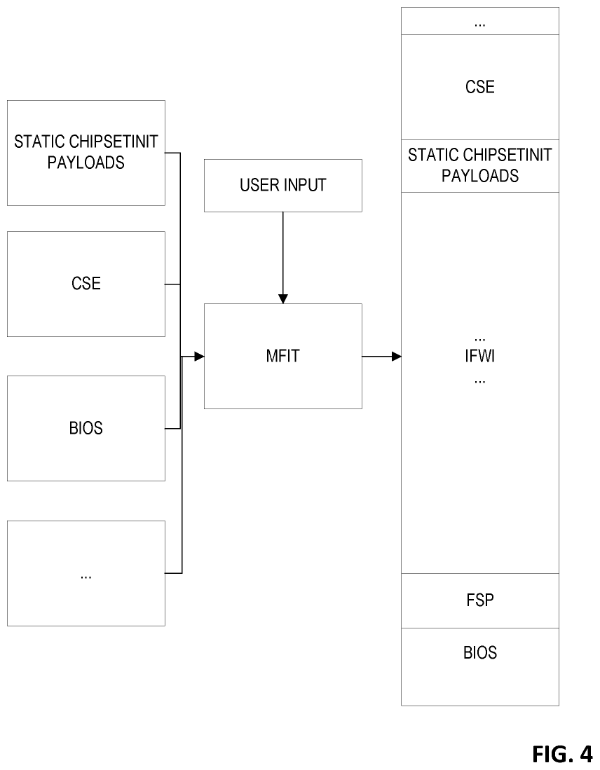

FIG. 4 depicts a conventional modular firmware imaging tool (mFIT) image creation process, which shows how hardware initialization content is conventionally prepared, authenticated, and incorporated into the firmware image prior to system deployment. As shown, PMC 102 first performs native PMC-driven IP bring-up and executes any preexisting static initialization payloads that have been placed into PMC SRAM. In parallel, CSE/ESE 104 retrieves hardware initialization tables from SPI flash memory, authenticates them, and transfers the authenticated tables into PMC SRAM for execution. This reflects the conventional approach in which initialization payloads are statically embedded in the firmware image generated by the firmware image creation tool and are loaded into PMC memory during early boot.

Following CPU Reset Deassertion, CPU 106 proceeds with policy-driven IP bring-up and evaluates system conditions, including whether exceptions exist, whether initialization payloads are already present, or whether a payload update policy is enabled. Under the conventional flow associated with current mFIT image creation, payloads are generally assumed to be present and valid, having been generated during firmware image construction rather than dynamically at runtime. Accordingly, when no exception conditions are detected, the system continues normal initialization without regenerating payloads, relying on the statically generated payload content previously stored in SPI flash and transferred into PMC SRAM by CSE/ESE 104.

The figure further illustrates the security and validation steps associated with this static image creation approach. Authentication of initialization payloads may be performed by CSE/ESE 104, and only upon successful authentication are the payloads stored in SPI flash memory and marked as existing for future boot cycles. Status flags are set to indicate payload presence and to disable further payload generation during normal operation. In this manner, the current mFIT image creation flow may emphasize offline generation of hardware initialization tables, secure incorporation of those tables into the firmware image, and reuse of the same static payloads across system boots, with the CPU-centric firmware assuming the payloads remain valid unless exceptional conditions arise.

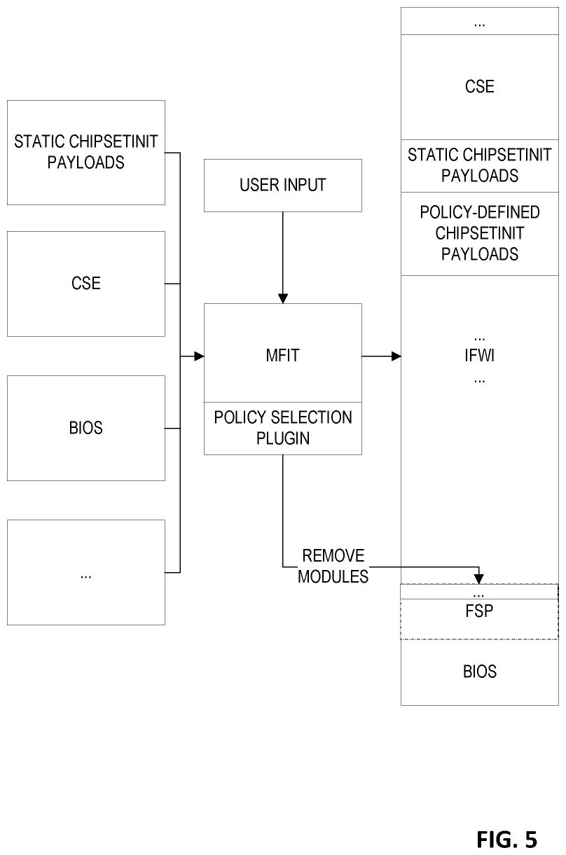

FIG. 5 depicts an mFIT image creation process according to the disclosure, which includes a redesigned firmware image assembly workflow in which hardware initialization payloads are explicitly generated, integrated, and used to streamline the overall firmware content. As shown in the diagram, the modular Firmware Image Tool (mFIT) receives inputs including BIOS components, security engine firmware managed by CSE/ESE 104, and a set of static HIA payloads that represent precomputed hardware register programming sequences. These components are combined into the integrated firmware image (IFWI), which is ultimately stored in SPI flash memory. In addition to static payloads, the figure shows the inclusion of policy-defined HIA payloads, which are generated based on user input and selected configuration policies.

A policy selection plugin interfaces with user input to define which hardware initialization behaviors are required for a particular platform configuration. These policy selections are passed through the Firmware Support Package (FSP), which determines the corresponding HIA payloads to be generated or included in the firmware image. Unlike the prior mFIT process, which largely assumed a fixed set of static initialization tables, the new workflow explicitly supports multiple payload types tied to platform-specific policies, allowing the firmware image to be tailored to known hardware configurations and usage scenarios.

A significant difference highlighted in this new mFIT process is the ability to remove unneeded firmware modules from the BIOS and FSP when their functionality is replaced by HIA payload execution on embedded controllers. As indicated by the “Remove Modules” stage in the figure, initialization code that would traditionally execute on the host CPU can be excluded from the final firmware image, reducing firmware size and eliminating redundant CPU-based initialization routines. In contrast to the previous figure, where payloads were statically generated and reused without altering the structure of CPU firmware modules, the new process integrates payload generation directly into firmware image creation and actively prunes unused firmware components. This results in a more compact, policy-optimized firmware image that is specifically designed to leverage offloaded hardware initialization, improving boot performance, reducing memory footprint, and enabling greater customization of silicon initialization flows.

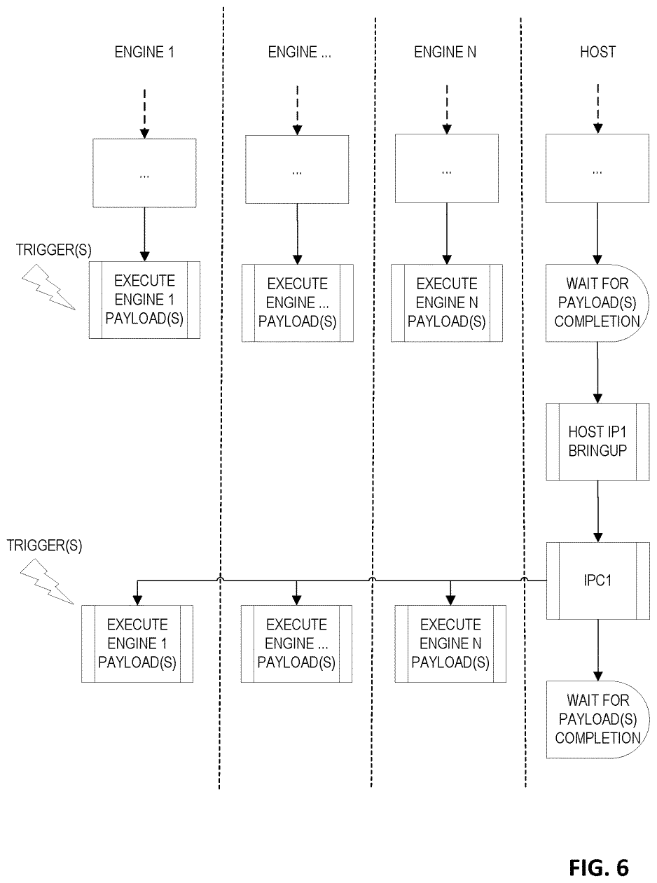

FIG. 6 depicts a generalized solution for this approach where a hardware programming accelerator (like the HIA function IP) is present in each engine where the IP programming can be offloaded. The HIA may be purpose built for each engine with required black-listed and white-listed register access endpoints governed by engine design. As shown, the system may include a plurality of engines, labeled Engine 1 through Engine N, each capable of executing one or more engine-specific initialization payloads. These payloads may include sequences of hardware configuration operations tailored to initialize corresponding IP blocks associated with each engine. The figure depicts each engine independently executing its assigned payloads in response to trigger signals, thereby enabling concurrent programming of multiple silicon components.

A host processing entity initiates initialization by issuing one or more trigger signals, such as IPC-based commands (illustrated as IPC1 and related triggers), to selected engines. Upon receiving a trigger, each targeted engine executes its associated payloads using its embedded hardware programming accelerator. The figure shows that multiple engines may perform payload execution in parallel, after which the host waits for confirmation of payload completion before proceeding with subsequent stages of system bring-up, such as host IP initialization (illustrated as Host IP1 Bringup). This coordinated trigger-and-wait mechanism ensures that hardware configuration operations are completed in the required order while still allowing maximum concurrency across engines.

This generalized model extends the concepts described in earlier figures beyond a single controller such as PMC 102 by enabling any embedded engine within the SoC to incorporate a hardware initialization accelerator. By distributing payload execution across multiple engines, the architecture supports scalable parallel silicon initialization, reduces reliance on host CPU firmware execution, and allows different classes of IP blocks to be configured by the most appropriate embedded controller. As a result, the figure illustrates a flexible framework in which hardware initialization workloads can be dynamically partitioned across multiple SoC engines to optimize boot time, efficiency, and system scalability

Initialization may be performed using idle SoC embedded controllers in parallel with other silicon initialization on the host CPU, thereby reducing the boot-time impact on CPU boot firmware. Boot time savings may be particularly beneficial to the end-consumer and may be associated with increased customer satisfaction. A proof-of-concept executed using the runtime approach as described herein resulted in savings of 40 milliseconds out of a total of 325 milliseconds of firmware support package (FSP) time for basic use-case where an USB keyboard, an USB mouse, an embedded display port (eDP) panel, and an OS-bootable non-volatile memory express (NVMe) drive was plugged in. Where the FSP component was the PCIe initialization, the procedure saved 35 milliseconds, and where the GPIO I/O standby configuration was used, 5 milliseconds were saved.

The principles and methods disclosed herein may result in manufacturing costs savings. Boot to OS and various end of manufacturing flows are required during production in a factory environment. Using the approach as disclosed herein in static saves platform boot-time, which increases manufacturing efficiency and translates to significant cost-savings as more products can be manufactured during the same amount of time.

The principles and methods disclosed herein may result in savings related to the overall bill of materials costs. CPU boot firmware sizes may decrease when using this approach, which may result in net SPI flash size savings despite an increase in HIA payload size potentially affecting the PMC SRAM size. However, many of these HIA payloads need not be loaded at boot and can be loaded in stages overwriting already executed HIA payloads. These HIA payloads may be optimized and can be compressed to minimal writes, unlike runtime CPU flows that use less efficient CPU-based instructions and logic. Moreover, only platform specific register programming may be present in the HIA payload versus generic code that should initialize any component using the controller present in the FSP. When the HIA payload is generated offline, the relevant runtime modules that generate these payloads can be removed from the FSP, further reducing SPI flash impact and boot time. Secure boot and measured boot requirements, which apply only to CPU boot firmware, are thus also reduced, thereby decreasing boot time. Note that usage of the Runtime approach as disclosed herein requires additional SPI flash space in the converged security engine (CSE)/embedded security engine (ESE) region, although boot-time savings are still applicable.

The principles and methods disclosed herein may result in additional benefits relative to security. CPU boot firmware code is typically visible to customers due to the distribution of the firmware support package (FSP) code. Although this FSP code is sometimes delivered as a signed binary, the assembly code running on the host CPU can still be visible to customers using debugging tools. Portions of the payload created by offline tools (e.g., using the Static approach as described herein) may not be visible, as they are executed by the PMC.

At various points during boot or as instructed by BIOS, the PMC may make calls to a hardware initialization accelerator function identifying portions of the hardware initialization accelerator payload to be executed. The hardware initialization accelerator payload may include one or more tables, with each table being assigned a unique table ID, followed by relevant register writes in a standardized format, concluding with an end-table marker, which may signal the termination of table execution. The hardware initialization accelerator function may process the register writes in the table and may halt upon detecting the end-table marker. This engine may be purpose-built to efficiently program a sequence of registers with minimal overhead.

Hardware initialization accelerator payload types may be understood as being among two types: (1) IPC-triggered, and (2) non-IPC triggered. The IPC-triggered hardware initialization accelerator payloads may need a unique IPC tied to the table type to allow the PMC to execute them. The non-IPC-triggered hardware initialization accelerator payloads may be executed at pre-defined points in the PMC boot-flow, such as based on specific non-IPC triggers during the boot-flow.

The hardware initialization accelerator payloads may be created in two ways: (1) runtime, or (2) static.

Regarding the runtime configuration, programming sequences can be stored as hardware initialization accelerator payloads during the end-of-manufacturing process for platforms where user input or connected peripheral devices may affect register programming flows. For initial values, the hardware initialization accelerator payload policy may be set to TRUE, and the hardware initialization accelerator payload present policy may be FALSE for subsequent flows to execute. The hardware initialization accelerator payload present policy is may be defined individually for each hardware initialization accelerator payload. The FSP can create either IPC-triggered or non-IPC-triggered payloads.

The PMC may check the write register's attributes against a pass list and if authenticity issues arise, an error may be flagged and made available as status for the FSP flow to disable the hardware initialization accelerator payload policy and continue using runtime logic on every boot. If the payload is successfully authenticated and executed, the hardware initialization accelerator payload present policy may be set to TRUE. This process is illustrated in FIG. 3.

Certain scenarios may trigger a complete re-run of the logical flow (e.g., the flow initially executed during the first boot at the end of manufacturing) to recreate the hardware initialization accelerator payload when user input or connected peripheral devices influence register programming flows. These scenarios include “Firmware Update in progress” and “BIOS policies modified.” Exceptions noted in the flowchart apply when these scenarios are TRUE.

Creating a non-IPC-triggered payload is advantageous in this context, as these payloads can be executed early, such as before FSP execution, thereby allowing for enhanced parallelism. If the FSP updates this payload during runtime, a platform reset may be required after the update to ensure the correct payload is executed, especially if registers defined in the table are write-once or if the IP cannot be reinitialized during runtime if already initialized.

Regarding the hardware initialization accelerator payload, these can be created offline, such as by using a tool such as the modular Firmware Image Tool (mFIT), when user input is not required and only known connected peripheral devices are utilized. These payloads may be integrated into the firmware image during its creation, thereby allowing for the generation of either IPC-triggered or non-IPC-triggered payloads. This approach enables users to optionally exclude unused FSP modules, thereby conserving SPI flash space and reducing boot time, as these components will not be copied to memory, authenticated, or executed. Additionally, generating IPC-triggered payloads with a tool can further reduce boot time during manufacturing, even if the FSP modules responsible for payload generation are retained. In such cases, the FSP modules are utilized only for generating payloads during firmware updates or exception scenarios.

These two methods can be used in combination with a single image. For example, if the GPIO hardware initialization accelerator payload(s) can be integrated using mFIT, and the PCIe related hardware initialization accelerator payload(s) can be delivered using runtime FSP code to SPI flash.

The Converged Security Engine (CSE) or Embedded Security Engine (ESE) may load all discovered hardware initialization accelerator payloads from the SPI flash into the Platform Management Controller's (PMC) SRAM early in the boot process. The PMC may then execute both non-IPC-triggered and IPC-triggered payloads from its SRAM. Multiple IPC signals can be defined to initiate different payloads at various stages within the Firmware Support Package (FSP) flow. A subsequent polling-based delay may be provided in the host CPU firmware to ensure the payload execution has been completed without errors. The delay is typically not expected but occasionally may happen due to slowdown of SoC components during programming or bigger than expected payload. This approach ensures that IP initialization adheres to the specific ordering and timing requirements set by the FSP. Previously, the PMC remained idle during silicon initialization, but this solution allows the Host CPU to offload tasks to the PMC, enhancing overall efficiency.

While the above descriptions and connected figures may depict components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

In some embodiments, the pass list referenced in the context of HIA payload validation may comprise a list of authorized access endpoints (i.e., authorized register access endpoints). The embedded controller, such as PMC 102, may compare the port identifier of each register write entry in the HIA payload against the pass list prior to executing the register write operation. If the port identifier of a register write entry does not match an entry in the pass list, the embedded controller may flag an error and make the error available as status information to the firmware support package flow, which may then disable the HIA payload policy and continue using runtime initialization logic on every subsequent boot. The pass list may be determined by the design of the embedded controller and may define which authorized access endpoints the embedded controller is authorized to program. The term “write register's attributes” as used herein may include at least the port identifier of the target register write entry. The pass list may include both whitelisted endpoints, which are authorized for programming, and blacklisted endpoints, which are prohibited from programming (i.e., unauthorized access endpoints), with the specific composition governed by the design of the embedded controller.

In some embodiments, the hardware initialization accelerator function, as referenced herein, may be understood as an execution engine (i.e., callable execution routine or instruction-processing engine) within the HIA. That is, the HIA may include the hardware initialization accelerator function as an internal processing capability. When the PMC or another embedded controller makes a call to the hardware initialization accelerator function, the hardware initialization accelerator function may process a designated portion of the HIA payload, such as a table identified by a unique table ID, by sequentially executing the register programming operations contained therein until an end-table marker is detected. The hardware initialization accelerator function thus represents the execution logic by which the hardware initialization accelerator applies register writes to hardware functional blocks.

In some embodiments, as used herein in the context of the boot flow, the term “exception” or “exception scenario” may refer to a system condition that requires re-evaluation or regeneration of one or more HIA payloads rather than reuse of previously stored payloads. Exception scenarios may include, without limitation, a firmware update being in progress, a modification to BIOS configuration policies, a change in connected peripheral devices, or the absence of a previously generated HIA payload. When an exception scenario is detected during policy-driven IP bring-up, the host processor may invoke the payload generation logic to create updated HIA payloads reflecting the changed system conditions.

In some embodiments, each register programming entry within the HIA payload may have a fixed-size format. By way of example, each entry may comprise 12 bytes in a standardized layout. The hardware initialization accelerator function may further support an optimized entry format of reduced size, such as 8 bytes per entry, to decrease the overall payload size when the full entry size is not required for a given register write operation. The choice between the full-size format and the optimized format may be determined at payload creation time based on the register write requirements of the targeted hardware functional blocks. The use of fixed-size entries may allow the hardware initialization accelerator function to process register writes sequentially with minimal parsing overhead.

In some embodiments, the boot time savings achievable by offloading hardware initialization operations to one or more embedded controllers may vary depending on the number and type of hardware functional blocks present in a given SoC implementation and on the number and type of connected peripheral devices. For example, offloading PCIe initialization operations, including a PCIe pre-speed-change configuration flow, and GPIO I/O standby configuration settings to the embedded controller for execution after CPU reset deassertion may result in boot time savings in a range of approximately 50 milliseconds to 200 milliseconds relative to a conventional CPU-driven initialization flow, depending on the specific stock keeping unit and the quantity of I/O devices and controllers present in the system.

In some embodiments, the embedded controllers utilized for hardware initialization payload execution, such as PMC 102, may operate in an execution environment that is not accessible by debugging tools associated with the host processor. That is, code and data executing on the embedded controller may not be observable using CPU-level debugging interfaces, including hardware debuggers, trace tools, or software-based debug agents executing on the host processor. As a result, the register programming sequences contained in HIA payloads executed by the embedded controller may not be directly visible to external parties, including parties with access to host CPU firmware debugging capabilities. This characteristic may provide an additional layer of protection for proprietary silicon initialization techniques when hardware initialization operations are relocated from host CPU firmware to the embedded controller.

In some embodiments, systems implementing the offloading approach (i.e., hardware initialization offloading approach) as disclosed herein may exhibit observable behavioral characteristics that differ from systems using conventional CPU-driven initialization. For platforms where user input or connected peripheral devices may affect register programming flows, the initialization timing of I/O devices relative to CPU reset may vary between a first boot (during which HIA payloads are generated) and subsequent boots (during which previously stored payloads are reused by the embedded controller). Additionally, modifying user-driven configuration policies or altering connected peripheral devices after a first boot may result in a change in the order or timing of I/O device initialization for the immediately following boot, with initialization behavior reverting to the payload-based sequence on subsequent boots after payload regeneration. For platforms where user input is fixed and peripheral devices remain unchanged, the firmware image generation tool may include configuration policies for payload creation and may additionally remove corresponding firmware modules from the system firmware, the presence or absence of which may be observable to a tool user.

In various aspects provided herein, in conventional system startup processes, silicon initialization of peripheral and I/O hardware functional blocks is performed serially by the host processor executing system firmware, which may contribute to a substantial portion of the pre-OS boot time. The host processor may spend time on polling operations, algorithmic processing of register programming sequences, and navigating the overhead of the BIOS execution environment, all of which cumulatively delay the transition from power-on to operating system loading. In various aspects described herein, one or more embedded controllers within the SoC that would otherwise remain idle during silicon initialization are utilized to execute HIA payloads in parallel with host processor operations. This parallel execution directly addresses the serial bottleneck by allowing hardware functional blocks such as PCIe controllers and GPIO controllers to be configured concurrently with CPU-driven initialization tasks, such as main memory bring-up, CPU-specific IP initialization, and policy-driven IP bring-up. The shift from a sequential initialization model to a coordinated parallel model reduces the aggregate time the host processor must dedicate to silicon initialization during the firmware support package execution phase.

In various aspects provided herein, two distinct methods for creating HIA payloads may be supported: a runtime method and a static method. The runtime method, as described in connection with FIG. 3, may be used for platforms where user input or connected peripheral devices may affect register programming flows. The static method, as described in connection with FIG. 5, may be used when the hardware configuration is predetermined and connected peripheral devices are known at firmware image creation time. These two methods may be used in combination within a single firmware image. For example, HIA payloads corresponding to GPIO I/O standby configuration may be generated statically and integrated into the firmware image using the modular Firmware Image Tool, while HIA payloads corresponding to PCIe initialization may be generated at runtime using firmware support package code and stored in SPI flash. This combinability allows users to tailor the payload creation strategy per hardware functional block based on whether the register programming sequences for that hardware functional block are fixed or variable across deployments.

In various aspects provided herein, relocating silicon initialization operations from the host processor to one or more embedded controllers may reduce the size of the system firmware stored in non-volatile memory. When HIA payloads are generated offline during firmware image creation, the firmware modules within the firmware support package that would otherwise perform the corresponding initialization on the host processor may be excluded from the firmware image, as described in connection with FIG. 5. This removal of firmware modules can reduce the SPI flash footprint of the system firmware. The reduction in firmware size may further decrease boot time because excluded modules need not be copied into memory, authenticated under secure boot requirements, or executed during system startup. Additionally, secure boot and measured boot operations, which apply to host CPU firmware, are correspondingly reduced in scope when the firmware support package contains fewer modules. The HIA payloads themselves may be compact relative to the firmware modules they replace, because the payloads may contain only platform-specific register programming entries rather than generic initialization logic capable of configuring any component variant.

In various aspects provided herein, the HIA may enforce access control over register write operations through the use of a pass list. The pass list may define the set of authorized access endpoints that the embedded controller is authorized to program. Each register write entry in the HIA payload specifies a target access endpoint, and the hardware initialization accelerator function may verify the target access endpoint against the pass list before executing the write operation. If the target access endpoint is not present in the pass list, the embedded controller may reject the register write and report an error. This pass list mechanism may serve as a security boundary that constrains the scope of register programming operations executable by the embedded controller, thereby limiting the potential impact of a malformed or unauthorized HIA payload. The pass list may include both whitelisted endpoints (authorized for programming) and blacklisted endpoints (prohibited from programming), with the specific composition of the pass list governed by the design of the embedded controller and the requirements of the hardware functional blocks associated with that embedded controller.

In various aspects provided herein, the host processor may coordinate the execution of HIA payloads by the embedded controller through an IPC trigger-and-wait mechanism. The host processor may transmit one or more IPC signals to the embedded controller at designated points during the firmware support package execution flow, where each IPC signal instructs the embedded controller to execute a specific HIA payload or set of payloads associated with that IPC signal. Following transmission of the IPC signal, the host processor may continue with other initialization operations, such as main memory bring-up, while the embedded controller executes the triggered payload. A polling-based delay may be provided in the host CPU firmware after the parallel operations to verify that the payload execution by the embedded controller has completed without errors prior to proceeding with initialization stages that depend on the configured hardware functional blocks. This trigger-and-wait mechanism can ensure that the hardware initialization operations performed by the embedded controller are completed in the required order and timing relative to the overall boot flow, while allowing maximum temporal overlap between host processor tasks and embedded controller payload execution.

In various aspects provided herein, HIA payloads loaded into the memory of the embedded controller, such as PMC SRAM, need not all be resident simultaneously. Many HIA payloads need not be loaded at boot and may instead be loaded in stages, with payloads that have already been executed being overwritten in the embedded controller memory by subsequently needed payloads. This staged loading approach allows the embedded controller to execute a total payload volume that exceeds the available SRAM capacity of the embedded controller, because only the payloads required for a given boot stage need be present in SRAM at that time. The HIA payloads may further be compressed or optimized to contain minimal register write entries, unlike runtime CPU flows that may use less efficient CPU-based instructions and logic to accomplish the same register programming. As a result, the net impact on embedded controller SRAM size may be limited even when a substantial number of hardware initialization operations are offloaded from the host processor.

In various aspects provided herein, the principles described herein may be generalized beyond a single embedded controller, as depicted in FIG. 6, to a multi-engine architecture in which a plurality of embedded engines within the SoC each incorporate a hardware initialization accelerator. Each engine may be configured to execute engine-specific HIA payloads to initialize the hardware functional blocks associated with that engine. The host processor may issue IPC-based trigger signals to multiple engines, and the engines may perform payload execution concurrently with each other and with host processor operations. This multi-engine architecture enables scalable parallel silicon initialization in which different classes of hardware functional blocks are configured by the most appropriate embedded controller. By distributing hardware initialization workloads across multiple engines, the architecture reduces the concentration of initialization tasks on any single controller and supports dynamic partitioning of initialization workloads to accommodate different SoC configurations and stock keeping unit variants.

Following paragraphs include examples in accordance with various aspects described herein:

Example 1 includes a computing system including: a host processor configured to execute system firmware during a system startup process; one or more hardware functional blocks requiring initialization during the startup process; and an embedded controller coupled to the host processor; wherein the host processor is configured, during execution of the system firmware, to: perform one or more firmware-based hardware initialization routines; identify one or more hardware initialization operations for offloading from the host processor to the embedded controller; generate, at runtime, at least one hardware initialization payload comprising a sequence of register programming operations corresponding to the identified hardware initialization operations; and transfer the at least one hardware initialization payload to memory accessible by the embedded controller.

Example 2 includes the computing system of Example 1, further including the embedded controller; wherein the embedded controller is configured to execute the at least one hardware initialization payload to configure the one or more hardware functional blocks.

Example 3 includes the computing system of Example 1 or 2, wherein the embedded controller is configured to execute the at least one hardware initialization payload in parallel with additional hardware initialization operations performed by the host processor.

Example 4 includes the computing system of any one of Examples 1 to 3, wherein the embedded controller is a first embedded controller; wherein the at least one hardware initialization payload comprises a first hardware initialization payload and a second hardware initialization payload; further including a second embedded controller; wherein the first embedded controller is configured to execute the first hardware initialization payload to configure a first hardware functional block of the one or more hardware functional blocks using the first hardware initialization payload; and wherein the second embedded controller is configured to execute the second hardware initialization payload to configure a second hardware functional block of the one or more hardware functional blocks using the second hardware initialization payload.

Example 5 includes the computing system of any one of Examples 1 to 4, further including a security engine configured to authenticate the hardware initialization payload prior to execution by the embedded controller.

Example 6 includes the computing system of Example 5, wherein the security engine is configured to verify integrity and authorization of the hardware initialization payload stored in non-volatile memory before loading the payload into memory of the embedded controller.

Example 7 includes the computing system of any one of Examples 1 to 6, wherein the host processor is configured to cause execution of the hardware initialization payload by transmitting an inter-processor communication signal to the embedded controller.

Example 8 includes the computing system of any one of Examples 2 to 7, wherein the embedded controller is configured to execute the hardware initialization payload in parallel with additional hardware initialization operations performed by the host processor.

Example 9 includes the computing system of any one of Examples 2 to 8, wherein the embedded controller is configured to execute at least one hardware initialization payload automatically at a predefined stage of the system startup process prior to execution of silicon initialization modules of the system firmware executed by the host processor.

Example 10 includes the computing system of any one of Examples 2 to 9, wherein the at least one hardware initialization payload comprises a non-inter-processor-communication-triggered payload that is executed by the embedded controller following native embedded controller bring-up and before execution of silicon initialization routines of a firmware support package by the host processor.

Example 11 includes the computing system of any one of Examples 2 to 10, wherein the embedded controller is configured to execute at least one hardware initialization payload prior to host processor execution of firmware routines for silicon component initialization.

Example 12 includes the computing system of any one of Examples 2 to 11, wherein the hardware initialization payloads comprise: (a) one or more inter-processor-communication-triggered payloads executed by the embedded controller in response to a signal from the host processor; and (b) one or more non-inter-processor-communication-triggered payloads executed automatically by the embedded controller at predefined stages of the system startup process.

Example 13 includes the computing system of any one of Examples 2 to 12, wherein a first hardware initialization payload is executed by the embedded controller in response to an inter-processor communication signal from the host processor, and a second hardware initialization payload is executed by the embedded controller without host processor signaling at a predefined boot-flow point.

Example 14 includes the computing system of any one of Examples 2 to 13, wherein the embedded controller is configured to execute at least one hardware initialization payload autonomously based on a boot-stage condition independent of inter-processor communication from the host processor.

Example 15 includes the computing system of any one of Examples 1 to 14, wherein the host processor is further configured to store the hardware initialization payload in non-volatile memory for reuse during subsequent system startup processes.

Example 16 includes the computing system of any one of Examples 1 to 15, wherein the host processor is configured to selectively regenerate the hardware initialization payload in response to at least one of a firmware update, a configuration policy change, or a change in connected peripheral devices.

Example 17 includes the computing system of any one of Examples 1 to 16, wherein the hardware initialization payload comprises a structured table of register programming entries terminated by an end marker indicating completion of payload execution.

Example 18 includes the computing system of any one of Examples 1 to 17, wherein the system firmware stored in non-volatile memory excludes one or more silicon initialization modules whose hardware initialization functionality is implemented by the hardware initialization payload executed by the embedded controller.

Example 19 includes a method performed by a host processor executing system firmware during a system startup process, the method including: performing, by the system firmware, initial platform bring-up operations including execution of one or more firmware-based hardware initialization routines; identifying, during the startup process, one or more hardware initialization operations suitable for offloading from the host processor to an embedded controller of a system-on-chip; generating, by the system firmware at runtime, at least one hardware initialization payload comprising a sequence of register programming operations corresponding to the identified hardware initialization operations; transferring the at least one hardware initialization payload to memory accessible by the embedded controller; and causing the embedded controller to execute the at least one hardware initialization payload to configure one or more hardware functional blocks of the system-on-chip.

Example 20 includes the method of Example 19, further including executing, by the embedded controller, at least one hardware initialization payload prior to execution of silicon initialization routines of the system firmware by the host processor.

Example 21 includes the method of Example 19 or 20, further including authenticating, by a security engine, the at least one hardware initialization payload prior to execution of the at least one hardware initialization payload by the embedded controller.

Example 22 includes the method of any one of Examples 19 to 21, further including storing the at least one hardware initialization payload in non-volatile memory upon successful authentication for reuse during one or more subsequent system startup processes.

Example 23 includes the method of any one of Examples 19 to 22, wherein causing the embedded controller to execute the at least one hardware initialization payload comprises transmitting, by the host processor, one or more inter-processor communication signals to the embedded controller, each inter-processor communication signal initiating execution of a respective hardware initialization payload at a designated stage within a firmware support package flow.

Example 24 includes the method of any one of Examples 19 to 23, further including executing, by the embedded controller, the at least one hardware initialization payload in parallel with hardware initialization operations performed by the host processor.

Example 25 includes the method of any one of Examples 19 to 24, wherein the at least one hardware initialization payload comprises a structured table of register programming entries terminated by an end-table marker indicating completion of payload execution.

Example 26 includes the method of any one of Examples 19 to 25, wherein the at least one hardware initialization payload comprises a non-inter-processor-communication-triggered payload that is executed by the embedded controller at a predefined stage of a boot flow of the embedded controller before execution of silicon initialization routines of a firmware support package by the host processor.

Example 27 includes the method of any one of Examples 19 to 26, further including selectively regenerating the at least one hardware initialization payload in response to at least one of a firmware update, a configuration policy change, or a change in connected peripheral devices.

Example 28 includes the method of any one of Examples 19 to 27, wherein the system firmware stored in non-volatile memory excludes one or more silicon initialization modules whose hardware initialization functionality is implemented by the hardware initialization payload executed by the embedded controller.

Example 29 includes a non-transitory computer readable medium including instructions which are configured to, if executed by one or more processors, cause the one or more processors to perform the method of any one of Examples 19 to 28.

Example 30 includes a method including: identifying one or more hardware initialization operations suitable for offloading from a host processor to an embedded controller of a system-on-chip; generating at least one hardware initialization payload comprising a sequence of register programming operations corresponding to the identified hardware initialization operations; transferring the at least one hardware initialization payload to memory accessible by the embedded controller; performing, by system firmware, initial platform bring-up operations including execution of one or more firmware-based hardware initialization routines; and causing the embedded controller to execute the at least one hardware initialization payload to configure one or more hardware functional blocks of the system-on-chip.

Example 31 includes the method of Example 30, further including removing from the system firmware instructions corresponding to the at least one hardware initialization payload transferred to the embedded controller.

Example 32 includes the method of Example 30 or 31, wherein causing the embedded controller to execute the at least one hardware initialization payload includes: executing a first payload in response to an inter-processor communication signal from the host processor; and executing a second payload automatically at a predefined stage of the system startup process without host processor signaling.

Example 33 includes the method of any one of Examples 30 to 32, further including authenticating, by a security engine, the at least one hardware initialization payload prior to execution of the at least one hardware initialization payload by the embedded controller.

Example 34 includes the method of any one of Examples 30 to 33, further including storing the at least one hardware initialization payload in non-volatile memory upon successful authentication for reuse during one or more subsequent system startup processes.

Example 35 includes the method of any one of Examples 30 to 34, wherein the at least one hardware initialization payload comprises a structured table of register programming entries assigned a unique table identifier, followed by register write operations in a standardized format, and terminated by an end-table marker indicating completion of payload execution.

Example 36 includes the method of any one of Examples 30 to 35, wherein the at least one hardware initialization payload comprises a non-inter-processor-communication-triggered payload that is executed by the embedded controller at a predefined stage of a boot flow of the embedded controller before execution of silicon initialization routines of a firmware support package by the host processor.

Example 37 includes the method of any one of Examples 30 to 36, wherein the at least one hardware initialization payload comprises an inter-processor-communication-triggered payload requiring a unique inter-processor communication signal tied to a table type of the at least one hardware initialization payload to cause execution of the at least one hardware initialization payload by the embedded controller.

Example 38 includes the method of any one of Examples 30 to 37, wherein causing the embedded controller to execute the at least one hardware initialization payload comprises transmitting, by the host processor, one or more inter-processor communication signals to the embedded controller, each inter-processor communication signal initiating execution of a respective hardware initialization payload at a designated stage within a firmware support package flow.

Example 39 includes the method of any one of Examples 30 to 38, further including selectively regenerating the at least one hardware initialization payload in response to at least one of a firmware update being in progress or a modification to a configuration policy of the system firmware.

Example 40 includes the method of any one of Examples 30 to 39, further including excluding from the system firmware one or more silicon initialization modules whose hardware initialization functionality is implemented by the at least one hardware initialization payload executed by the embedded controller.

Example 41 includes the method of any one of Examples 30 to 40, wherein causing the embedded controller to execute the at least one hardware initialization payload comprises issuing trigger signals to a plurality of embedded controllers within the system-on-chip to initiate concurrent execution of respective hardware initialization payloads by the plurality of embedded controllers, and waiting for confirmation of payload completion from the plurality of embedded controllers before proceeding with subsequent stages of the system startup process.

Example 42 includes the method of any one of Examples 30 to 41, further including providing, in host processor firmware, a polling-based delay to verify that execution of the at least one hardware initialization payload by the embedded controller has completed without errors prior to proceeding with an initialization stage of the system startup process that depends on the configured one or more hardware functional blocks.

Example 43 includes a computing system including: a host processor configured to execute system firmware during a system startup process; one or more hardware functional blocks requiring initialization during the startup process; and an embedded controller coupled to the host processor; wherein at least one hardware initialization payload comprising a sequence of register programming operations for configuring the one or more hardware functional blocks is generated offline during firmware image creation and stored in non-volatile memory; and wherein the embedded controller is configured, during the system startup process, to load and execute the at least one hardware initialization payload to initialize the one or more hardware functional blocks.

Example 44 includes the computing system of Example 43, further including a security engine configured to load the at least one hardware initialization payload from non-volatile memory into memory of the embedded controller early in the system startup process.

Example 45 includes the computing system of Example 43 or 44, wherein the embedded controller is configured to execute the at least one hardware initialization payload prior to execution of silicon initialization routines of the system firmware by the host processor.

Example 46 includes the computing system of any one of Examples 43 to 45, wherein the at least one hardware initialization payload comprises a non-inter-processor-communication-triggered payload that is executed by the embedded controller at a predefined stage of a boot flow of the embedded controller before execution of silicon initialization routines of a firmware support package by the host processor.

Example 47 includes the computing system of any one of Examples 43 to 46, wherein the at least one hardware initialization payload comprises an inter-processor-communication-triggered payload that is executed by the embedded controller in response to an inter-processor communication signal received from the host processor.

Example 48 includes the computing system of any one of Examples 43 to 47, wherein the host processor is configured to transmit one or more inter-processor communication signals to the embedded controller at designated stages within a firmware support package flow to initiate execution of respective hardware initialization payloads.

Example 49 includes the computing system of any one of Examples 43 to 48, wherein the at least one hardware initialization payload comprises a structured table of register programming entries assigned a unique table identifier, followed by register write operations in a standardized format, and terminated by an end-table marker indicating completion of payload execution.

Example 50 includes the computing system of any one of Examples 43 to 49, wherein the system firmware stored in non-volatile memory excludes one or more silicon initialization modules whose hardware initialization functionality is implemented by the at least one hardware initialization payload executed by the embedded controller.

Example 51 includes the computing system of any one of Examples 43 to 50, wherein the embedded controller is configured to execute the at least one hardware initialization payload in parallel with hardware initialization operations performed by the host processor.

Example 52 includes the computing system of any one of Examples 43 to 51, wherein a plurality of hardware initialization payloads are loaded into memory of the embedded controller in stages during the system startup process, with a previously executed hardware initialization payload in the memory of the embedded controller being overwritten by a subsequently loaded hardware initialization payload.

Example 53 includes the computing system of any one of Examples 43 to 52, wherein host processor firmware is configured to provide a polling-based delay to verify that execution of the at least one hardware initialization payload by the embedded controller has completed without errors prior to proceeding with an initialization stage of the system startup process that depends on the configured one or more hardware functional blocks.

Example 54 includes a method including: generating, during firmware image creation using a firmware image generation tool, at least one hardware initialization payload comprising a sequence of register programming operations for configuring one or more hardware functional blocks of a system-on-chip; storing the at least one hardware initialization payload in non-volatile memory as part of a firmware image; and executing, by an embedded controller during a system startup process, the at least one hardware initialization payload to initialize the one or more hardware functional blocks.

Example 55 includes the method of Example 54, wherein generating the at least one hardware initialization payload comprises generating at least one of: an inter-processor-communication-triggered payload requiring an inter-processor communication signal from a host processor to initiate execution by the embedded controller; or a non-inter-processor-communication-triggered payload executable by the embedded controller at a predefined stage of the system startup process without an inter-processor communication signal from the host processor.

Example 56 includes the method of Example 54 or 55, further including authenticating, by a security engine, the at least one hardware initialization payload prior to loading the at least one hardware initialization payload into memory of the embedded controller.

Example 57 includes the method of any one of Examples 54 to 56, further including loading, by a security engine, the at least one hardware initialization payload from non-volatile memory into memory of the embedded controller early in the system startup process.

Example 58 includes the method of any one of Examples 54 to 57, wherein executing the at least one hardware initialization payload by the embedded controller during the system startup process is performed in parallel with hardware initialization operations performed by a host processor.

Example 59 includes the method of any one of Examples 54 to 58, further including removing from the firmware image one or more firmware modules configured to perform hardware initialization operations corresponding to the at least one hardware initialization payload.

Example 60 includes the method of any one of Examples 54 to 59, further including transmitting, by a host processor, one or more inter-processor communication signals to the embedded controller at designated stages within a firmware support package flow to initiate execution of respective hardware initialization payloads.

Example 61 includes the method of any one of Examples 54 to 60, wherein the at least one hardware initialization payload comprises a structured table of register programming entries assigned a unique table identifier, followed by register write operations in a standardized format, and terminated by an end-table marker indicating completion of payload execution.

Example 62 includes the method of any one of Examples 54 to 61, wherein a plurality of hardware initialization payloads are loaded into memory of the embedded controller in stages during the system startup process, with a previously executed hardware initialization payload in the memory of the embedded controller being overwritten by a subsequently loaded hardware initialization payload.

Example 63 includes the method of any one of Examples 54 to 62, further including providing, in host processor firmware, a polling-based delay to verify that execution of the at least one hardware initialization payload by the embedded controller has completed without errors prior to proceeding with an initialization stage of the system startup process that depends on the configured one or more hardware functional blocks.

Example 64 includes the method of any one of Examples 54 to 63, further including generating, at runtime during the system startup process by a host processor, at least one further hardware initialization payload for a hardware initialization operation for which user input or a connected peripheral device affects the register programming sequence, and storing the at least one further hardware initialization payload in non-volatile memory for execution by the embedded controller during a subsequent system startup process.

Example 65 includes a method including: generating, during firmware image creation, at least one hardware initialization payload for execution by an embedded controller; integrating the hardware initialization payload into a firmware image stored in non-volatile memory; and removing from the firmware image one or more firmware modules configured to perform hardware initialization operations corresponding to the hardware initialization payload.

Example 66 includes the method of Example 65, wherein generating the at least one hardware initialization payload comprises generating at least one inter-processor-communication-triggered payload requiring an inter-processor communication signal from a host processor to initiate execution of the at least one inter-processor-communication-triggered payload by the embedded controller.

Example 67 includes the method of Example 65 or 66, wherein generating the at least one hardware initialization payload comprises generating at least one non-inter-processor-communication-triggered payload executable by the embedded controller at a predefined stage of a system startup process without an inter-processor communication signal from a host processor.

Example 68 includes the method of any one of Examples 65 to 67, further including generating, at runtime by system firmware during a system startup process, at least one further hardware initialization payload for a hardware initialization operation for which user input or connected peripheral devices affect register programming sequences, and storing the at least one further hardware initialization payload in non-volatile memory for execution by the embedded controller, wherein the at least one further hardware initialization payload and the at least one hardware initialization payload integrated into the firmware image are used in combination during the system startup process.

Example 69 includes the method of any one of Examples 65 to 68, further including receiving user input via a policy selection plugin interfacing with the firmware image generation tool, wherein the user input defines hardware initialization behaviors required for a platform configuration, and wherein generating the at least one hardware initialization payload is based on the received user input.

Example 70 includes the method of any one of Examples 65 to 69, wherein generating the at least one hardware initialization payload comprises passing policy selections through a firmware support package to determine one or more hardware initialization payloads corresponding to the policy selections.

Example 71 includes the method of any one of Examples 65 to 70, wherein the at least one hardware initialization payload comprises a structured table of register programming entries assigned a unique table identifier, followed by register write operations in a standardized format, and terminated by an end-table marker indicating completion of payload execution.

Example 72 includes the method of any one of Examples 65 to 71, further including authenticating, by a security engine, the at least one hardware initialization payload, wherein integrating the at least one hardware initialization payload into the firmware image is performed only upon successful authentication by the security engine.

Example 73 includes the method of any one of Examples 65 to 72, wherein generating the at least one hardware initialization payload comprises generating a plurality of hardware initialization payloads, each hardware initialization payload of the plurality of hardware initialization payloads corresponding to hardware initialization operations of a respective hardware functional block of a system-on-chip.

Example 74 includes the method of any one of Examples 65 to 73, wherein the embedded controller is a platform management controller, and wherein integrating the at least one hardware initialization payload into the firmware image comprises storing the at least one hardware initialization payload in a region of non-volatile memory accessible by a security engine for loading into memory of the platform management controller during a system startup process.

Example 75 includes the method of any one of Examples 65 to 74, wherein generating the at least one hardware initialization payload comprises generating at least one inter-processor-communication-triggered payload using the firmware image generation tool, wherein the at least one inter-processor-communication-triggered payload is used during the system startup process, and wherein one or more firmware modules of the firmware image responsible for generating hardware initialization payloads are retained in the firmware image for use during firmware updates or exception scenarios.

Example 76 includes a computing system including: a host processor configured to execute system firmware during a system startup process; one or more hardware functional blocks requiring initialization during the startup process; and an embedded controller coupled to the host processor; wherein the host processor is configured to identify one or more hardware initialization operations for offloading from the host processor to the embedded controller, to generate at least one hardware initialization payload comprising a sequence of register programming operations corresponding to the identified hardware initialization operations, and to transfer the at least one hardware initialization payload to memory accessible by the embedded controller; and wherein the embedded controller is configured to execute the at least one hardware initialization payload to configure one or more hardware functional blocks of the system-on-chip.

Example 77 includes the computing system of Example 76, wherein the system firmware stored in non-volatile memory excludes one or more silicon initialization modules whose hardware initialization functionality is implemented by the at least one hardware initialization payload executed by the embedded controller.

Example 78 includes the computing system of Example 76 or 77, wherein the host processor is configured to cause execution of a first hardware initialization payload in response to an inter-processor communication signal, and to cause execution of a second hardware initialization payload automatically at a predefined stage of the system startup process without inter-processor communication signaling.

Example 79 includes the computing system of any one of Examples 76 to 78, further including a security engine configured to authenticate the at least one hardware initialization payload prior to execution of the at least one hardware initialization payload by the embedded controller.

Example 80 includes the computing system of any one of Examples 76 to 79, wherein the host processor is further configured to store the at least one hardware initialization payload in non-volatile memory upon successful authentication for reuse during one or more subsequent system startup processes.

Example 81 includes the computing system of any one of Examples 76 to 80, wherein the at least one hardware initialization payload comprises a structured table of register programming entries assigned a unique table identifier, followed by register write operations in a standardized format, and terminated by an end-table marker indicating completion of payload execution.

Example 82 includes the computing system of any one of Examples 76 to 81, wherein the at least one hardware initialization payload comprises a non-inter-processor-communication-triggered payload that is executed by the embedded controller at a predefined stage of a boot flow of the embedded controller before execution of silicon initialization routines of a firmware support package by the host processor.

Example 83 includes the computing system of any one of Examples 76 to 82, wherein the at least one hardware initialization payload comprises an inter-processor-communication-triggered payload requiring a unique inter-processor communication signal tied to a table type of the at least one hardware initialization payload to cause execution of the at least one hardware initialization payload by the embedded controller.

Example 84 includes the computing system of any one of Examples 76 to 83, wherein the host processor is configured to transmit one or more inter-processor communication signals to the embedded controller, each inter-processor communication signal initiating execution of a respective hardware initialization payload at a designated stage within a firmware support package flow.

Example 85 includes the computing system of any one of Examples 76 to 84, wherein the host processor is configured to selectively regenerate the at least one hardware initialization payload in response to at least one of a firmware update being in progress or a modification to a configuration policy of the system firmware.

Example 86 includes the computing system of any one of Examples 76 to 85, wherein the system firmware stored in non-volatile memory excludes one or more silicon initialization modules whose hardware initialization functionality is implemented by the at least one hardware initialization payload executed by the embedded controller.

Example 87 includes the computing system of any one of Examples 76 to 86, further including a plurality of embedded controllers within the system-on-chip, each embedded controller of the plurality of embedded controllers being configured to execute respective hardware initialization payloads concurrently in response to trigger signals issued by the host processor, wherein the host processor is configured to wait for confirmation of payload completion from the plurality of embedded controllers before proceeding with subsequent stages of the system startup process.

Example 88 includes the computing system of any one of Examples 76 to 87, wherein host processor firmware is configured to provide a polling-based delay to verify that execution of the at least one hardware initialization payload by the embedded controller has completed without errors prior to proceeding with an initialization stage of the system startup process that depends on the configured one or more hardware functional blocks.

What is claimed is:

1. A computing system comprising:
a host processor configured to execute system firmware during a system startup process;
one or more hardware functional blocks requiring initialization during the startup process; and
an embedded controller coupled to the host processor;
wherein the host processor is configured, during execution of the system firmware, to:
perform one or more firmware-based hardware initialization routines;
identify one or more hardware initialization operations for offloading from the host processor to the embedded controller;
generate, at runtime, at least one hardware initialization payload comprising a sequence of register programming operations corresponding to the identified hardware initialization operations; and
transfer the at least one hardware initialization payload to memory accessible by the embedded controller.

2. The computing system of claim 0, further comprising the embedded controller; and
wherein the embedded controller is configured to execute the at least one hardware initialization payload to configure the one or more hardware functional blocks.

3. The computing system of claim 2, wherein the embedded controller is configured to execute the hardware initialization payload in parallel with additional hardware initialization operations performed by the host processor.

4. The computing system of claim 2, wherein the embedded controller is configured to execute at least one hardware initialization payload automatically at a predefined stage of the system startup process prior to execution of silicon initialization modules of the system firmware executed by the host processor.

5. The computing system of claim 2, wherein the at least one hardware initialization payload comprises a non-inter-processor-communication-triggered payload that is executed by the embedded controller following native embedded controller bring-up and before execution of silicon initialization routines of a firmware support package by the host processor.

6. The computing system of claim 2, wherein the embedded controller is configured to execute at least one hardware initialization payload prior to host processor execution of firmware routines for silicon component initialization.

7. The computing system of claim 2, wherein the hardware initialization payloads comprise:
(a) one or more inter-processor-communication-triggered payloads executed by the embedded controller in response to a signal from the host processor; and
(b) one or more non-inter-processor-communication-triggered payloads executed automatically by the embedded controller at predefined stages of the system startup process.

8. The computing system of claim 2, wherein a first hardware initialization payload is executed by the embedded controller in response to an inter-processor communication signal from the host processor, and a second hardware initialization payload is executed by the embedded controller without host processor signaling at a predefined boot-flow point.

9. The computing system of claim 0, wherein the embedded controller is configured to execute the at least one hardware initialization payload in parallel with additional hardware initialization operations performed by the host processor.

10. The computing system of claim 0, wherein the embedded controller is a first embedded controller; wherein the at least one hardware initialization payload comprises a first hardware initialization payload and a second hardware initialization payload; further comprising a second embedded controller; and
wherein the first embedded controller is configured to execute the first hardware initialization payload to configure a first hardware functional block of the one or more hardware functional blocks using the first hardware initialization payload; and wherein the second embedded controller is configured to execute the second hardware initialization payload to configure a second hardware functional block of the one or more hardware functional blocks using the second hardware initialization payload.

11. The computing system of claim 0, further comprising a security engine configured to authenticate the hardware initialization payload prior to execution by the embedded controller.

12. The computing system of claim 11, wherein the security engine is configured to verify integrity and authorization of the hardware initialization payload stored in non-volatile memory before loading the payload into memory of the embedded controller.

13. The computing system of claim 1, wherein the host processor is configured to cause execution of the hardware initialization payload by transmitting an inter-processor communication (IPC) signal to the embedded controller.

14. The computing system of claim 1, wherein the host processor is configured to selectively regenerate the hardware initialization payload in response to at least one of a firmware update, a configuration policy change, or a change in connected peripheral devices.

15. The computing system of claim 1, wherein the hardware initialization payload comprises a structured table of register programming entries terminated by an end marker indicating completion of payload execution.

16. The computing system of claim 1, wherein the system firmware stored in non-volatile memory excludes one or more silicon initialization modules whose hardware initialization functionality is implemented by the hardware initialization payload executed by the embedded controller.

17. A computing system comprising:
a host processor configured to execute system firmware during a system startup process;
one or more hardware functional blocks requiring initialization during the startup process; and
an embedded controller coupled to the host processor; wherein the host processor is configured to:
identify one or more hardware initialization operations for offloading from the host processor to the embedded controller,
generate at least one hardware initialization payload comprising a sequence of register programming operations corresponding to the identified hardware initialization operations, and
transfer the at least one hardware initialization payload to memory accessible by the embedded controller; and
wherein the embedded controller is configured to execute the at least one hardware initialization payload to configure one or more hardware functional blocks of the system-on-chip.

18. The computing system of claim 17, herein the embedded controller is configured to execute a first payload in response to an inter-processor communication signal from the host processor, and execute a second payload automatically at a predefined stage of the system startup process without host processor signaling.

19. A computing system comprising:
a host processor configured to execute system firmware during a system startup process;
one or more hardware functional blocks requiring initialization during the startup process; and
an embedded controller coupled to the host processor;
wherein at least one hardware initialization payload comprising a sequence of register programming operations for configuring the one or more hardware functional blocks is generated offline during firmware image creation and stored in non-volatile memory; and
wherein the embedded controller is configured, during the system startup process, to load and execute the at least one hardware initialization payload to initialize the one or more hardware functional blocks.

20. The computing system of claim 19, wherein the embedded controller is configured to execute the at least one hardware initialization payload prior to execution of silicon initialization routines of the system firmware by the host processor.
